(19) United States
(12) Patent Application Publication
(10) Pub. No.: US 2010/0082546 A1
(43) Pub. Date: Apr. 1, 2010

(54) Storage Tiers for Database Server System

(75) Inventors: Mahesh K. Sreenivas, Sammamish, WA (US); Robert H. Gerber, Bellevue, WA (US); Vishal Kathuria, Woodinville, WA (US); John F. Ludeman, Sammamish, WA (US); Ashwin Shrinivas, Sammamish, WA (US); Michael A. Uhlar, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/241,912

(22) Filed: Sep. 30, 2008

(51) Int. Cl. G06F 17/30

(52) U.S. Cl. 707/641; 707/E17.005

(57) ABSTRACT

A technique is described for storing data from a database across a plurality of data storage devices, wherein each data storage device is capable of being accessed only by a corresponding computer system in a group of interconnected computer systems. In accordance with the technique, an identifier of the database is received. An identifier of a storage tier instance is also received, wherein the storage tier instance comprises a logical representation of one or more storage locations within each of the data storage devices. Responsive to the receipt of the identifier of the database and the identifier of the storage tier instance, data from the database is stored in two or more of the storage locations logically represented by the storage tier instance, wherein each of the two or more storage locations in which data is stored is within a corresponding one of the data storage devices.

### BACKGROUND

A database server is a computer program that is configured to provide database services to other computer programs or computers, which are typically referred to as clients. Such database services may include, for example, storing data in a database, retrieving data from a database, modifying data stored in a database, or performing other services relating to the management and utilization of data stored in databases. To perform these functions, a database server may be configured to perform functions such as searching, sorting, and indexing of data stored in databases.

It is in the interest of administrators and users of database servers that such servers provide good performance, high availability, and scalability. In addition, such servers should provide ease of use, administration and management.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method is described herein for storing data from a database across a plurality of data storage devices, wherein each data storage device is capable of being accessed only by a corresponding computer system in a group of interconnected computer systems. In accordance with the method, an identifier of the database is received. An identifier of a storage tier instance is also received, wherein the storage tier instance comprises a logical representation of one or more storage locations within each of the data storage devices. Responsive to the receipt of the identifier of the database and the identifier of the storage tier instance, data from the database is stored in two or more of the storage locations logically represented by the storage tier instance, wherein each of the two or more storage locations in which data is stored is within a corresponding one of the data storage devices.

A system is also described herein. The system includes a plurality of interconnected computer systems and a plurality of data storage devices. Each of the data storage devices is connected to a corresponding one of the interconnected computer systems and is solely accessible thereto. The system further includes computer program logic executing on at least one of the interconnected computer systems. The computer program logic includes a command processor and a data virtualization manager. The command processor is configured to receive an identifier of a database and to receive an identifier of a storage tier instance, wherein the storage tier instance comprises a logical representation of one or more storage locations within each of the data storage devices. The data virtualization manager is configured to store data from the database in two or more of the storage locations logically represented by the storage tier instance responsive to receipt of the identifier of the database and the identifier of the storage tier instance by the command processor, wherein each of the two or more storage locations in which data is stored is within a corresponding one of the data storage devices.

A computer program product is also described herein. The computer program product comprises a computer-readable medium having computer program logic recorded thereon for enabling a processing unit to store data from a database across a plurality of data storage devices, wherein each data storage device is capable of being accessed only by a corresponding computer system in a group of interconnected computer systems. The computer program logic includes first means, second means and third means. The first means is for enabling the processing unit to receive an identifier of the database. The second means is for enabling the processing unit to receive an identifier of a storage tier instance, wherein the storage tier instance comprises a logical representation of one or more storage locations within each of the data storage devices. The third means is for enabling the processor to store data from the database in two or more of the storage locations logically represented by the storage tier instance responsive to receiving the identifier of the database and the identifier of the storage tier instance, wherein each of the two or more storage locations in which data is stored is within a corresponding one of the data storage devices.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example database system in which an embodiment of the present invention may be implemented.

FIG. 2 is a block diagram of a database system in which a brick, which comprises an instance of a database server and a corresponding instance of cluster infrastructure logic, is installed and executed upon a single computer system.

FIG. 3 is a block diagram of a database system in which two or more bricks are installed and executed upon the same computer system.

FIG. 4 is a block diagram of a data storage device that includes a plurality of storage locations.

FIG. 5 is a block diagram that shows a representative instance of cluster infrastructure logic.

FIG. 6 is a block diagram showing one or more manager(s) that may be included within an instance of cluster infrastructure logic.

FIG. 7 is a block diagram showing a plurality of agents that are included within an instance of cluster infrastructure logic.

FIG. 8 is a diagram that illustrates the relationship between a table and partitions derived therefrom.

FIG. 9 is a diagram that illustrates the relationship between a partition and fragments derived therefrom.

FIG. 10 is a block diagram of a database system in which clones, which comprise physical manifestations of fragments, are distributed across data storage devices associated with different computer systems.

FIG. 11 is a block diagram that depicts entities that may be involved in performing functions relating to the creation, altering or dropping of a storage tier instance.

FIG. 12 depicts a flowchart of an example method by which a storage tier may be created.

FIG. 13 depicts a flowchart of an example method by which an existing storage tier instance may be altered to associate one or more new storage locations with the storage tier instance.

FIG. 14 depicts a flowchart of an example method by which an existing storage tier instance may be altered to disassociate one or more storage locations from the storage tier instance.

FIG. 15 depicts a flowchart of an example method by which an existing storage tier instance may be dropped.

FIG. 16 is a block diagram that depicts entities that may be involved in performing functions relating to the assignment of a database to a storage tier instance and the storage of data from the database in accordance therewith.

FIG. 17 depicts a flowchart of a method by which a database may be associated with a storage tier instance and by which data from the database may be stored in accordance therewith.

FIG. 18 depicts an example processor-based computer system that may be used to implement various aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### A. Example Operating Environment

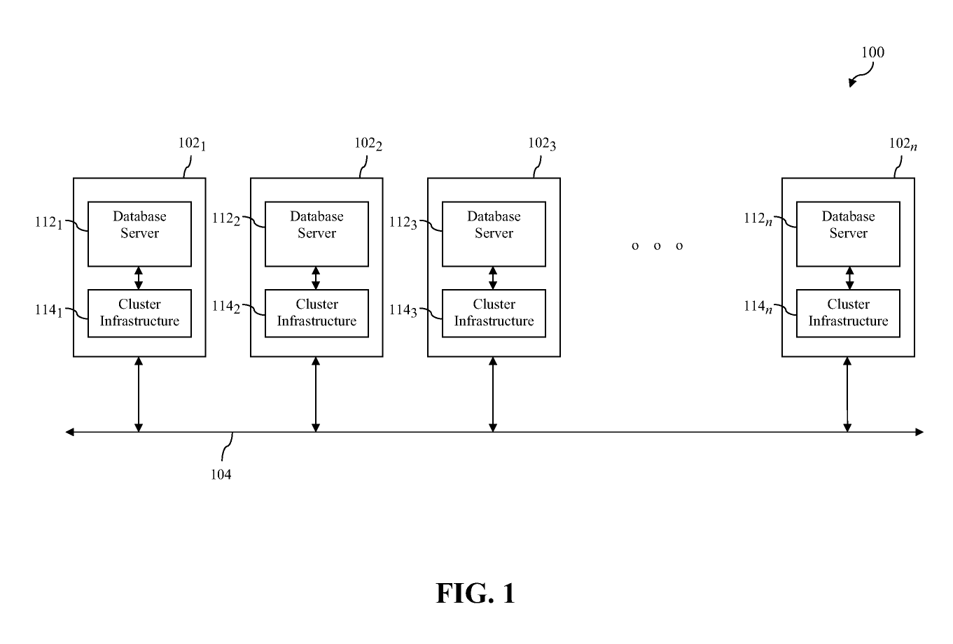

FIG. 1 is a block diagram of an example database system 100 in which an embodiment of the present invention may be implemented. As shown in FIG. 1, system 100 includes a plurality of bricks, denoted bricks 102₁, 102₂, 102₃, . . . , 102ₙ, where n denotes the total number of bricks in system 100. Each brick comprises an instance of a database server 112 and an instance of cluster infrastructure logic 114 communicatively coupled thereto. In particular, brick 102₁ comprises an instance of database server 112₁ and an instance of cluster infrastructure logic 114₁ communicatively coupled thereto, brick 102₂ comprises an instance of database server 112₂ and an instance of cluster infrastructure logic 1142 communicatively coupled thereto, and so forth and so on. Although system 100 is shown as including more than three bricks, it is to be understood that system 100 may also include only two bricks or only three bricks. As further shown in FIG. 1, each brick 102₁-102ₙ is connected to every other brick 102₁-102ₙ via a communication infrastructure 104.

Each database server instance 112₁-112ₙ comprises an instance of a computer program that is configured to provide database services to other computer programs or computers, which are referred to herein as clients. Such database services may include, for example, storing data in a database, retrieving data from a database, modifying data stored in a database, or performing other services relating to the management and utilization of data stored in databases. To perform these functions, each database server instance 112₁-112ₙ may be configured to perform functions such as searching, sorting, and indexing of data stored in databases. In one embodiment, each instance of database server 112₁-112ₙ comprises an edition of Microsoft® SQL Server®, published by Microsoft Corporation of Redmond, Wash., although the invention is not so limited.

Each instance of cluster infrastructure logic 114₁-114ₙ comprises computer program logic that is configured to enable the plurality of database server instances 112₁-112ₙ to operate together as a single logical database system, such that a single system image is presented to every user/client that interacts with a database server instance 112₁-112ₙ. Each instance of cluster infrastructure logic 114₁-114ₙ is also configured to allow data associated with a single database to be simultaneously stored, retrieved, modified or otherwise processed by a plurality of database server instances 112₁-112ₙ.

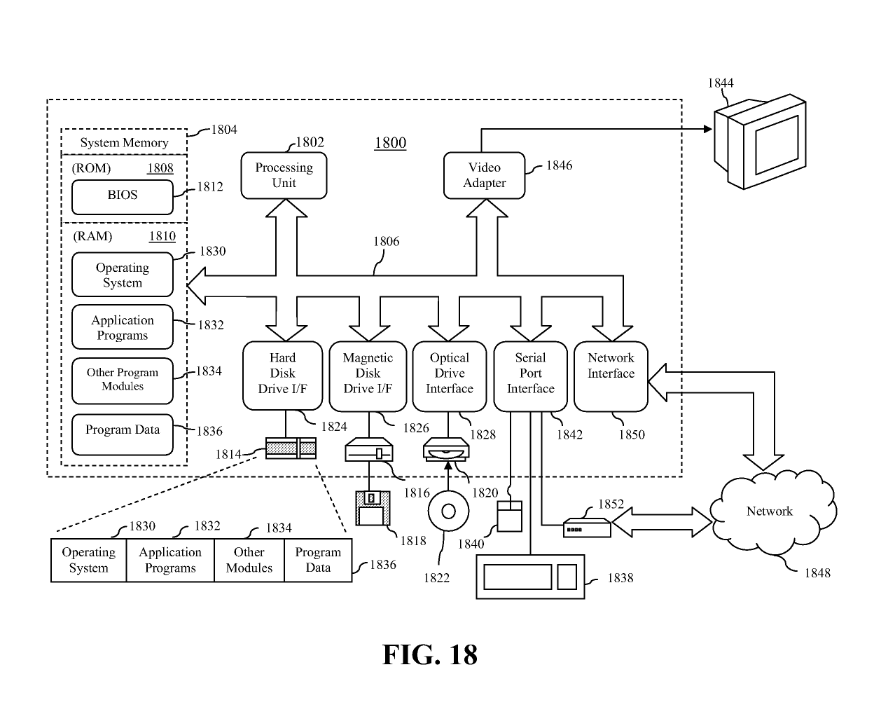

In one implementation of database system 100, each combination of database server instance 112₁-112ₙ and corresponding cluster infrastructure instance 114₁-114ₙ shown in FIG. 1 is installed upon a corresponding processor-based computer system and is executed thereon to perform the aforementioned functions as well as other functions. An example of one such processor-based computer system is described elsewhere herein in reference to FIG. 18.

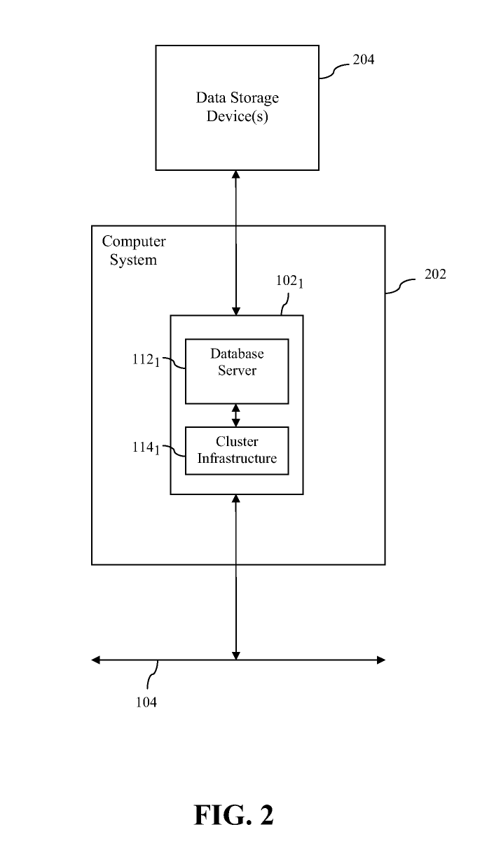

For example, FIG. 2 is a block diagram of one implementation of database system 100 in which brick 102₁, which comprises database server instance 112₁ and cluster infrastructure logic instance 114₁, is installed and executed upon a single processor-based computer system 202. As shown in FIG. 2, computer system 202 is connected to communication infrastructure 104 and to one or more data storage devices 204. In one implementation, data storage device(s) 204 are accessible only to computer system 202. In such an implementation, any database data to be stored, retrieved, modified or otherwise processed by database server instance 112₁ within the context of database system 100 will be stored on data storage device(s) 204 attached to computer system 202.

Data storage device(s) 204 may include any type of direct-attached storage (DAS) device, including but not limited to hard drives, optical drives, or other types of drives that may be directly attached to computer system 202 via a standard interface such as a Serial Advanced Technology Attachment (SATA) interface, a Small Computer System Interface (SCSI), a Serial Attached SCSI (SAS) interface, or a Fibre Channel interface. Data storage device(s) 204 may also comprise any type of data storage devices accessible via a storage area network (SAN) or any form of network-attached storage (NAS).

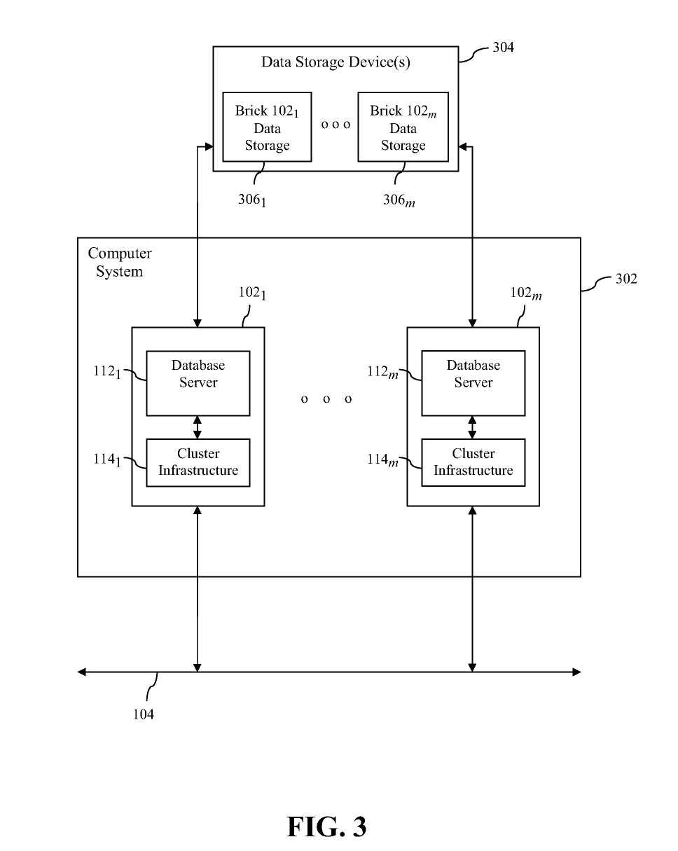

In an alternate implementation of database system 100, two or more bricks may be installed and executed upon the same processor-based computer system. A block diagram of such an implementation is shown in FIG. 3. As shown in FIG. 3, a plurality of bricks 102₁-102ₘ, each of which comprises a corresponding database server instance and cluster infrastructure logic instance, is installed and executed upon a single processor-based computer system 302. The number of bricks installed on computer system 302, denoted m, is preferably less than the total number of bricks in database system 100, denoted n. As further shown in FIG. 3, computer system 302 is connected to communication infrastructure 104 and to one or more data storage devices 304. In one implementation, data storage device(s) 304 are accessible only to computer system 302. In such an implementation, any database data to be stored, retrieved, modified or otherwise processed by database server instances 112₁-112ₘ within the context of database system 100 will be stored on data storage device(s) 304 attached to computer system 302. Database data stored on data storage device(s) 304 is not shared between bricks 102₁-102ₘ. Rather each brick has its own corresponding data storage, denoted data storage 306₁-306ₘ in FIG. 3. For example, if database data is stored in files within data storage device(s) 304, each file will be exclusive to one of bricks 102₁-102ₘ. As another example, if database data is stored in a raw storage format, physical disks within data storage device(s) 304 will be exclusive to corresponding ones of bricks 102₁-102ₘ.

In FIGS. 1-3, communication infrastructure 104 is intended to represent any communication infrastructure capable of carrying data from one computer system to another. For example, in one implementation, communication infrastructure 104 comprises a high-speed local area network (LAN) implemented using Gigabit Ethernet technology, InfiniBand® technology, or the like. However, these examples are not intended to be limiting and other communication infrastructures may be used.

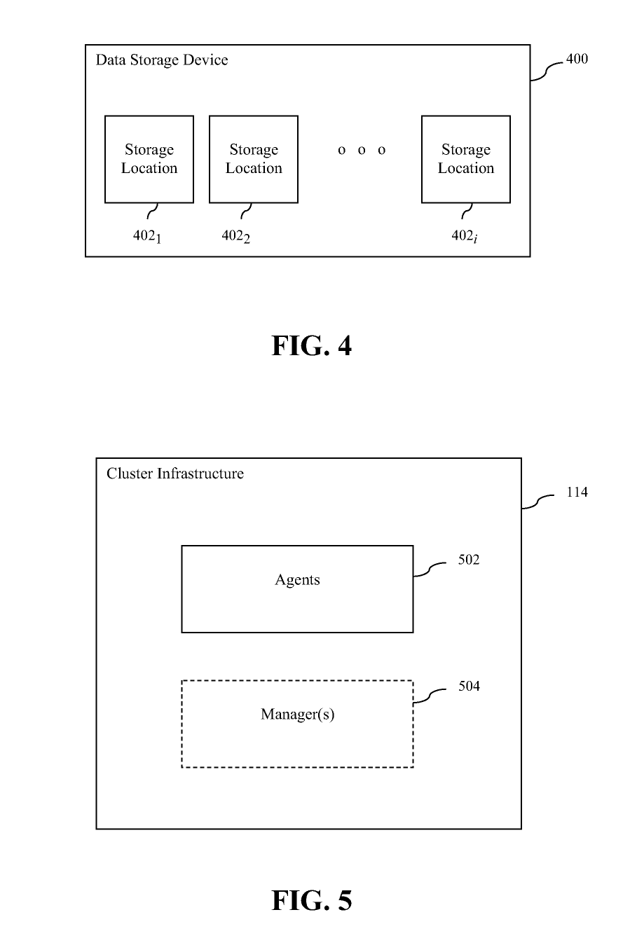

FIG. 4 is a block diagram of a data storage device 400, which may represent any of data storage device(s) 204 as discussed above in reference to FIG. 2 or any of data storage device(s) 304 as discussed above in reference to FIG. 3. As shown in FIG. 4, data storage device 400 includes a plurality of storage locations 4021, 402₂, . . . , 402ᵢ. Each such storage location may comprise, for example, a volume identifiable by and accessible to a file system associated with a computer system to which data storage device 400 is attached. Each such storage location may also comprise a logical unit of storage that includes one or more volumes. Each such logical unit may be identified using a logical unit number (LUN).

FIG. 5 is a block diagram that shows a single representative instance 114 of the plurality of cluster infrastructure logic instances 114₁-114ₙ in more detail. As shown in FIG. 5, each instance of cluster infrastructure logic 114₁-114ₙ includes a plurality of agents 502 and optionally includes one or more managers 504.

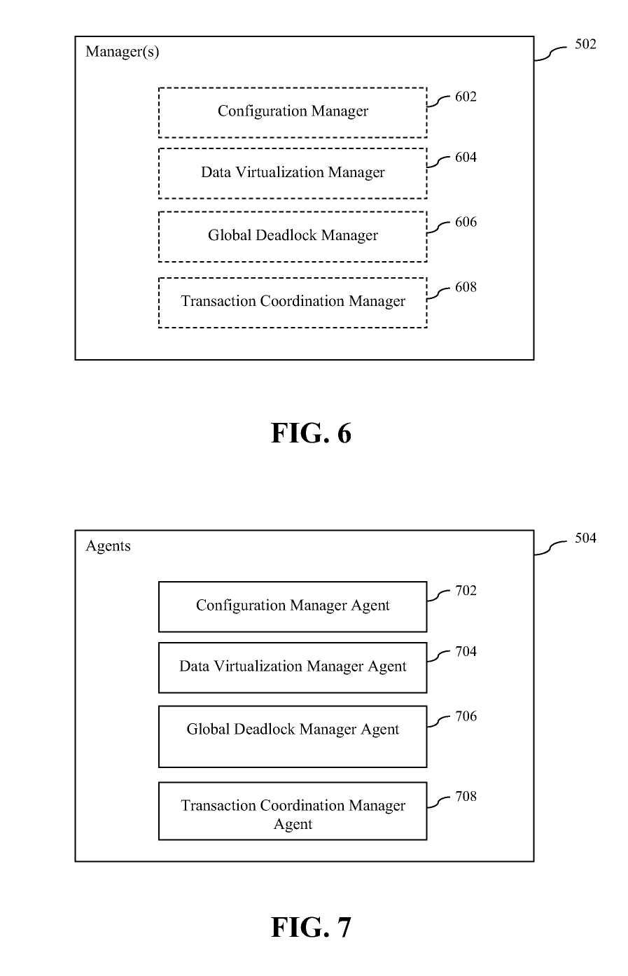

Each of manager(s) 504 is configured to control the performance of certain functions necessary to enable the plurality of database server instances 112₁-112ₙ to operate together as a single logical database system and to allow data associated with a single database to be simultaneously stored, retrieved, modified or otherwise processed by a plurality of database server instances 112₁-112₁. As shown in FIG. 6, manager(s) 504 may include one or more of a configuration manager 602, a data virtualization manager 604, a global deadlock manager 606 and a transaction coordination manager 608.

Configuration manager 602 is the key cluster manager and orchestrates critical activities such as the startup and shutdown of other managers and agents, reconfiguration of the cluster, so and so forth.

Data virtualization manager 604 is responsible for data virtualization. It makes decisions regarding where all user data should be placed, as well as where metadata associated with such user data should be placed. Data virtualization manager 604 is also responsible for load balance for purposes of achieving scalability and avoiding bottlenecks. Data virtualization manager 604 implements policies to trade scalability against availability and alignment of data.

In one implementation of database system 100, an instance of each of the aforementioned manager types is included within only a subset of the n instances of cluster infrastructure logic 114₁-114ₙ. Thus, for example, an instance of data virtualization manager 604 may be included within only 2 instances of cluster infrastructure logic 114₁-114ₙ in an implementation in which n is greater than 2. This serves to conserve resources but also allows for some degree of redundancy should a manager that is currently executing fail. Only one instance of each manager type is permitted to make decisions at any given time. Each manager is configured to carry out its appointed functions by sending commands to and receiving information from a corresponding instance of an agent located within each instance of cluster infrastructure logic 114₁-114ₙ. As shown in FIG. 7, these agents 504 include a configuration manager agent 702, a data virtualization manager agent 704, a global deadlock manager agent 706 and a transaction coordination manager agent 708.

Database system 100 achieves high availability in part by providing the plurality of database server instances 112₁-112ₙ executing on a plurality of different computer systems, each of which can be used to access a single logical database. If a database server instance or the computer system upon which it is executing fails, one or more other database server instances executing on different computer systems may be used to obtain database services.

Database system 100 achieves increased performance by storing data from a database across a plurality of data storage devices associated with the different computer systems upon which bricks 102₁-102ₙ are executing so that the workload associated with processing such data can be distributed across the computer systems.

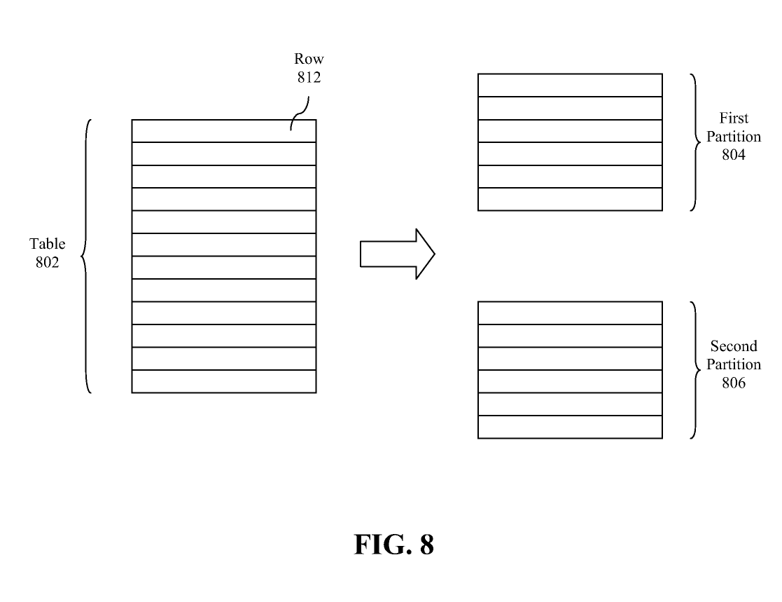

Database system 100 further achieves high availability by storing copies of the same database data across such data storage devices, such that if one computer system and/or the data storage device(s) associated therewith fail, an alternative copy of the same data may be accessed via a different computer system and associated data storage device(s). These concepts will now be illustrated with reference to FIGS. 8-10.

In particular, FIG. 8 depicts a table 802 in a database, which comprises a series of rows, such as exemplary row 812. Each database server instance 112₁-112ₙ is configured to provide a user with the ability to create such a table and, furthermore, to divide such a table to produce groups of rows which are called partitions. For example, as further shown in FIG. 8, table 802 may be divided into a first partition 804 and a second partition 806.

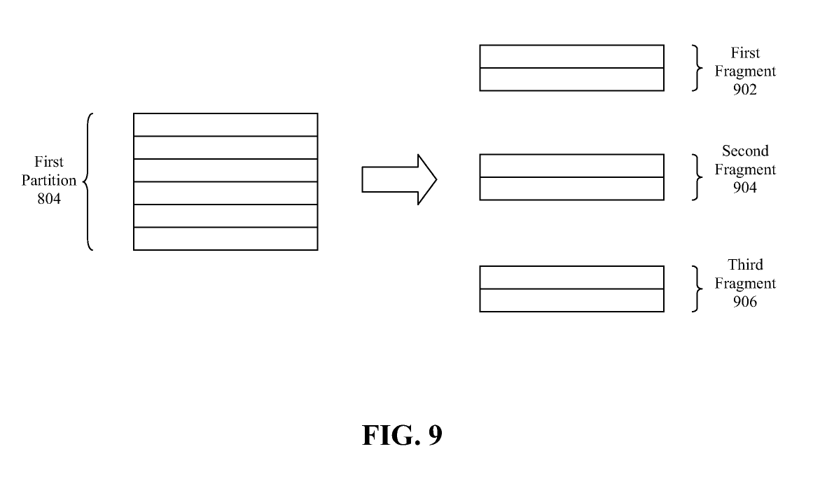

Data virtualization manager 604 is configured to further divide each partition into smaller groups of rows which are called fragments. For example, as shown in FIG. 9, first partition 804 may be divided into a first fragment 902, a second fragment 904 and a third fragment 906. Fragments are logical entities. Physical manifestations of fragments are called clones.

Data virtualization manager 604 is further configured to distribute clones across data storage devices associated with different computer systems to improve performance and provide high availability. Data virtualization manager 604 may determine the number of clones to be created and distributed across data storage devices based on a redundancy factor. The redundancy factor may be set by a system administrator or a user depending upon the implementation.

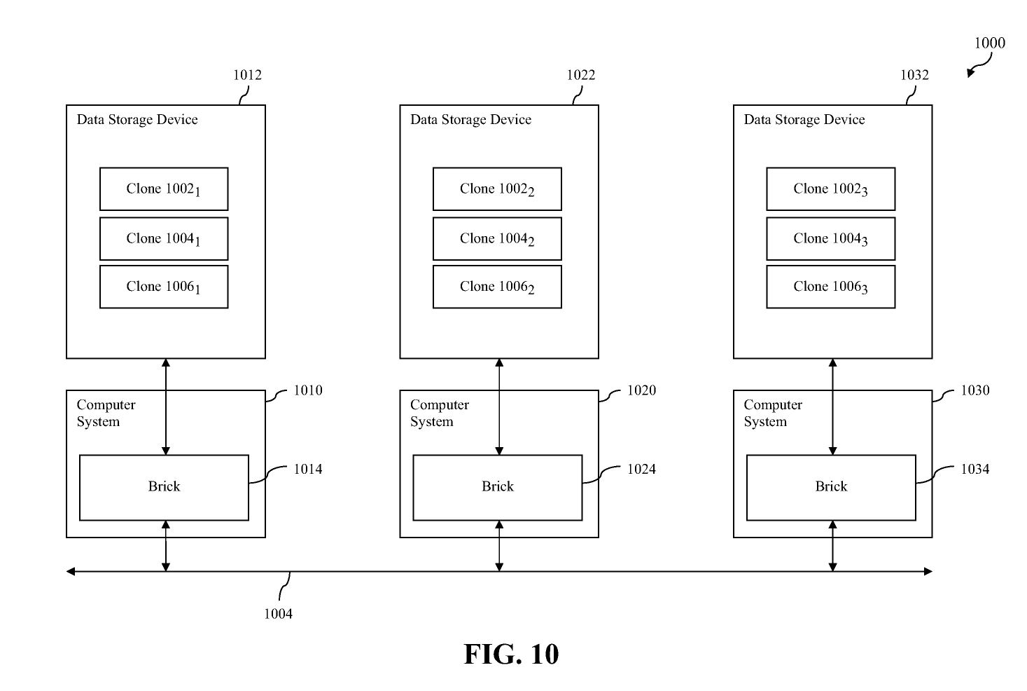

For example, FIG. 10 is a block diagram of one implementation of database system 100, denoted database system 1000, in which clones are distributed across data storage devices associated with different computer systems. As shown in FIG. 10, a computer system 1010 executing a brick 1014 is connected to a data storage device 1012, a computer system 1020 executing a brick 1024 is connected to a data storage device 1022, and a computer system 1030 executing a brick 1034 is connected to a data storage device 1032. The computer systems are connected via a communication infrastructure 1004. Assume that first fragment 902 of FIG. 9 is physically manifested as clones 1002₁, 1002₂ and 1002₃, that second fragment 904 of FIG. 9 is physically manifested as clones 1004₁, 1004₂ and 1004₃, and that third fragment 906 of FIG. 9 is physically manifested as clones 1006₁, 1006₂ and 1006₃.

As shown in FIG. 10, data virtualization manager 604 has distributed one clone associated with each fragment to each of data storage devices 1012, 102₂ and 1032, respectively. For example, clone 1002ₙ is stored within data storage device 1012, clone 1002₂ is stored within data storage device 102₂ and clone 1002₃ is stored within data storage device 1032. As a result, the workload associated with any process that operates on all three fragments 902, 904 and 906 that make up first partition 804 can easily be distributed across computer systems 1010, 1020, 1030 since each computer system has local access to the necessary data for performing the process. Furthermore, if any one of computer system 1010, 1020, 1030, or its associated data storage device should fail, the data logically represented by fragments 902, 904 and 906 is still accessible via any of the other computers systems and associated data storage devices.

The architecture of database system 1000 may be referred to as a “shared nothing” architecture since each computer system within system 1000 does not share any common resource with any of the other computer systems to access and process necessary database data. The architecture advantageously allows for easy scale out through the addition of new computer systems and data storage devices.

### B. Storage Tiers

Certain conventional database servers require a user to specify the physical location of where data associated with a particular database is to be stored. The storage specification may include, for example, one or more database files. The user may be required to specify the physical storage location as part of the database creation process.

Extending such a scheme to database system 100 as described in the preceding section poses a number of problems. For example, if the creator of a database is required to specify how data associated with a database is to be stored in the various data storage devices associated with the computer systems upon which bricks 102₁-102ₙ are executing, the single system image tenet of database system 100 will be violated.

Furthermore, if database system 100 is scaled up to include a larger number of computer systems and a larger number of associated data storage devices, the complexity associated with specifying storage locations across all the data storage devices increases commensurately.

Additionally, as noted above, a goal associated with database system 100 is high availability. This is achieved in database system 100, in part, through the coordinated creation and storage of multiple representations of the same database data across a plurality of different data storage devices associated with a plurality of different computer systems. This creation and storage scheme allows for seamless handling of issues such as the failure of bricks. Allowing a user to specify the precise physical location of where data associated with a database is to be stored may impede or disable such automated creation and storage functions.

Still further, in a database system in which the user is required to specify the physical location of where data associated with a database is to be stored, the user may be required to deal with issues of file-name proliferation that arise when multiple files associated with a single database are stored in different physical locations.

An embodiment of the present invention addresses each of the foregoing issues by providing system-wide logical storage containers, termed storage tiers. Each storage tier logically represents one or more storage locations. The storage locations logically represented by a storage tier may exist within a plurality of different data storage devices, wherein each of the plurality of different data storage devices may be accessible only to a corresponding computer system in a group of interconnected computer systems. The use of storage tiers advantageously enables a system such as database system 100 to present a single system image to a user on every brick that is part of the database system 100.

By providing storage tiers, an embodiment of the present invention provides a single system abstraction for storage that can be dealt with directly by users. Consequently, users need not be concerned with the fine-grained details and complexity associated with storing data across a large number of data storage devices. Such a single system abstraction provides a user with ease of use, administration and management in dealing with database system-wide storage requirements. Furthermore, the complexity involved in working with storage tiers advantageously remains constant regardless of the size of the database system.

The use of storage tiers also enables software entities such as data virtualization manager 604 to assume responsibility for the creation and storage of database data across a plurality of different data storage devices. As a result, the user need not be concerned with specifying the precise physical location of where data associated with a database is to be stored. The user also need not worry about file name proliferation issues since, in an embodiment, files are named automatically by system software entities.

1. Database Files and File Groups

To provide a better understanding of the properties and usage of storage tiers, a description of various classes of database data that may be associated with a storage tier in accordance with an embodiment of the present invention will now be described. This description is particularly relevant to an embodiment of database system 100 in which each instance of database server 112₁-112ₙ comprises an edition of Microsoft® SQL Server®, published by Microsoft Corporation of Redmond, Wash. However, the present invention is not limited to such an embodiment.

Databases in database system 100 may have three types of files: primary data files, secondary data files and log files. A primary data file is the starting point of the database and points to the other files in the database. Every database has one primary file. The recommended file name extension for primary data files is .mdf.

Secondary data files make up all the data files associated with a database other than the primary data file. Some databases may not have any secondary data files, while others have several secondary data files. The recommended file name extension for secondary data files is .ndf.

Log files hold all the log information that is used to recover a database. There must be at least one log file for each database, although there can be more than one. The recommended file name extension for log files is .ldf.

In database system 100, database objects and files can be grouped together in file groups for allocation and administration purposes. There are two types of file groups: primary and user-defined. The primary file group associated with a database contains the primary data file and any other files not specifically assigned to another file group. All pages for the system tables (which will be discussed below) are allocated in the primary file group. User-defined file groups are any file groups that are specified by using the FILEGROUP keyword in a CREATE DATABASE or ALTER DATABASE statement.

Log files are never part of a file group. Log space is managed separately from data space.

No file can be a member of more than one file group. Tables, indexes, and large object data can be associated with a specified file group. In this case, all pages will be allocated in that file group, or the tables and indexes can be partitioned. The data of partitioned tables and indexes is divided into units each of which can be placed in a separate file group in a database.

One file group in each database is designated the default file group. When a table or index is created without specifying a file group, it is assumed all pages will be allocated from the default file group. Only one file group at a time can be the default file group. Members of a db_owner fixed database role can switch the default file group from one file group to another. If no default file group is specified, the primary file group is the default file group.

System metadata associated with database system 100 may be stored in a number of system databases, each of which has a number of the foregoing file types. For example, system metadata may include a master database and a model database, each of which comprises data and log files. There are three kinds of metadata in system tables: logical metadata, physical metadata and persistent state/metadata of the configuration manager, transaction coordination manager and data virtualization manager.

Logical metadata is data that is replicated, or physically persisted, to data storage devices associated with every brick in database system 100. A software entity called a metadata manager is configured to perform this function.

Physical metadata describes metadata that is stored on a data storage device accessible only to a computer system upon which a particular brick is executing. There are no replicated copies and the system tables are modeled as having a separate data fragment on each database fragment. The contents of these tables are thus a union of all the physical metadata that is locally-stored with respect to each brick.

Configuration manager/transaction coordination manager/data virtualization manager metadata is replicated to data storage devices associated with certain bricks in accordance with a predefined algorithm. This metadata is treated as “physical metadata” from the point of view of a metadata manager.

2. Properties of Storage Tiers

A description of properties common to each instance of a storage tier in accordance with one embodiment of the present invention is provided in Table 1 below. Some of the properties that will be described are particularly relevant to an embodiment of database system 100 in which each instance of database server 112₁-112ₙ comprises an edition of Microsoft® SQL Server®, published by Microsoft Corporation of Redmond, Wash., although the use of storage tiers is not limited to such an embodiment.

TABLE 1
Description of Storage Tier

| Property | Values | Remarks |
|---|---|---|
| storage_tier_id | [1, k], where k is a 4-byte | System generated value. |
| | integer value. | Immutable property. Unique |
| | | across a given database system. |
| name | Any name that adheres | Provided by system for default |
| | to object naming convention. | instances. User to provided names for |
| | | additional instances. |
| | | Updatable using ALTER |
| | | STORAGE TIER command. |
| | | Unique across a given database |
| | | system. |
| type | {system_data, system_log, | Set during an instance creation. |
| | temp_data, temp_log, | Cannot be modified subsequently. |
| | data, log} | |
| is_default | Boolean | There is always one and exactly |
| | | one default instance of a given |
| | | storage tier type in the database |
| | | system. |
| storage_pool | A collection of storage | Updatable using ALTER |
| | specifications | STORAGE TIER command. |

As shown in Table 1, the properties of a storage tier instance are labeled storage_tier_id, name, type, is_default and storage_pool. The storage_tier_id property comprises an immutable value generated by a software entity within database system 100 that uniquely identifies a single storage tier instance for every brick within database system 100.

The name property comprises a name uniquely associated with a storage tier instance for every brick within database system 100. The name may be required to adhere to an object naming convention associated with database server instances 112₁-112ₙ, such as a Structured Query Language (SQL) object naming convention. In one implementation of database system 100, the system provides default storage tier instances for each type of storage tier. In such an implementation, the names associated with the default storage tier instances are provided by database system 100 while, in contrast, all user-created storage tier instances are named by a user. In one embodiment, the namespace used for naming storage tiers is a flat non-hierarchical namespace. As noted in Table 1, the name associated with a storage tier instance may be updated using an ALTER STORAGE TIER command, as will be described in more detail herein.

Each instance of a storage tier has a type property that is set during the creation of the storage tier instance. Once set, the type assigned to a storage tier instance cannot be modified. Storage tier types include but are not limited to system_data, system_log, temp_data, temp_log, data and log. These storage tier types will be described in more detail below.

The property is_default specifies whether or not a storage tier instance is a default instance of the storage tier. In one embodiment, there is only one default instance of a given storage tier type.

The property storage_pool identifies one or more storage specifications associated with a storage tier instance. An example of a storage specification in accordance with one embodiment of the present invention is described in Table 2 below. As shown in Table 2, the properties associated with a storage specification instance include a storage_tier_id, a storage_spec_id, a brick_id and a path.

TABLE 2
Description of Storage Specification

| Property | Values | Remarks |
|---|---|---|
| storage_tier_id | [1, m], where m is | Immutable property. |
| | a 4-byte integer | |
| | value. | |
| storage_spec_id | [1, k], where k is a | (storage_tier_id, |
| | 4-byte integer | storage_spec_id) is a |
| | value | composite key and is unique |
| | | across database system. |
| storage_spec_name | | Should adhere to the rules for |
| | | naming identifiers in database |
| | | server. Unique across a given |
| | | storage tier. |
| brick_id | [1, n], 4-byte | |
| | integer type | |
| path | <path to directory> | Path should always end with a |
| | | trailing backslash. |

The property storage_tier_id is an immutable value that uniquely identifies the storage tier instance with which a storage specification is associated.

The property storage_spec_id is a value that uniquely identifies the storage specification instance in relation to the storage tier instance identified by storage_tier_id. As noted in Table 2, the combination of storage_tier_id and storage_spec_id defines a composite key that uniquely identifies the storage specification for all bricks within database system 100.

The property storage_spec_name comprises a name associated with a storage specification. The storage_spec_name must be unique across any given storage tier instance and may be required to adhere to certain rules for naming identifiers associated with database server instances 112₁-112ₙ.

The property brick_id is a unique identifier of one of bricks 102₁-102ₙ within database system 100 with which the storage specification is associated.

The property path describes a path to a storage location within a data storage device associated with a computer system upon which the brick identified by brick_id is executing. As discussed above in reference to FIG. 4, a storage location may comprise, for example, a volume identifiable by and accessible to a file system associated with the computer system. As also discussed above in reference to FIG. 4, a storage location may comprise a logical unit of storage that includes one or more volumes, wherein the logical unit may be identified by a logical unit number (LUN).

3. Storage Tier Types

As discussed above in reference to Table 1, each storage tier instance has a type property. The type associated with a storage tier determines a number of properties for that storage tier including, but not limited to, the number of storage tier instances that may be created for that type, whether an instance of the storage tier may be created or dropped by a user, and the types of database files that may be associated with an instance of the storage tier.

Table 3 below identifies different types of storage tier instances in accordance with one embodiment of the present invention. Properties associated with each of these different storage tier types will be described below

TABLE 3
Storage Tier Types

| | Name of System-Provided | Number of Instances |
|---|---|---|
| Type | Instance | in Database System |
| system_data | StSystemData | 1 (system-provided only) |
| system_log | StSystemLog | 1 (system-provided only) |
| temp_data | StTempData | 1 (system-provided only) |
| temp_log | StTempLog | 1 (system-provided only) |
| data | StData | Users can create any number |
| log | StLog | Users can create any number |

Properties of system_data and system_log storage tier types. There can be one and only one instance of the storage tier of type system_data and system_log at any given time. These instances bear the names StSystemData and StSystemLog, respectively, and are provided by database system 100. These storage tier instances control the allocation of storage for system metadata associated with database system 100. In particular, the storage tier instance StSystemData controls the allocation of storage for the data files of the databases that constitute system metadata (e.g., master database and model database) while the storage tier instance StSystemLog controls the allocation of storage for the log files of the databases that constitute system metadata. In one embodiment of the present invention, storage for system metadata must be provisioned on one or more data storage device(s) associated with each of the bricks in database system 100.

Users are not allowed to drop the system-provided instances of the storage tiers of type system_data and system_log. Users also cannot create storage tier instances of the type system_data and system_log. Users can provision more storage or alter the provisioned storage associated with the system-provided instances of storage tier types system_data and system_log.

For each storage tier instance of the type system_data and system_log, the value of the is_default property is true and cannot be altered.

Properties of temp_data and temp_log storage tier types. There can be one and only one instance of the storage tier of type temp_data and temp_log at any given time. These instances bear the names StTempData and StTempLog, respectively, and are provided by database system 100. In an embodiment, tempdb describes a temporary database that is required for proper operation of each database server instance 112₁-112ₙ and that is provided at a global level (i.e., for use by all bricks) in an embodiment of database system 100. The storage tier instance StTempData controls the allocation of storage for the primary file group of tempdb while the storage tier instance StTempLog controls the allocation of storage for the log files of tempdb. In one embodiment of the present invention, storage for tempdb data and log files must be provisioned on one or more data storage device(s) associated with each of the bricks in database system 100.

Users are not allowed to drop the system-provided instances of the storage tiers of type temp_data and temp_log. Users also cannot create storage tier instances of the type temp_data and temp_log. Users can provision more storage or alter the provisioned storage associated with the system-provided instances of storage tier types temp_data and temp_log.

For each storage tier instance of the type temp_data and temp_log, the value of the is_default property is true and cannot be altered.

Properties of data and log storage tier types. Storage tier instances of the type data control the allocation of storage for data files associated with user-created databases while storage tier instances of the type log control the allocation of storage for log files associated with user-created databases. Users can create instances of data and log storage tier types only. Any number of instances may be created. In one embodiment, data and log files can be provisioned across any data storage device(s) associated with any bricks in database system 100. In a further embodiment, storage for log files for a given user-created database must be provisioned on the same brick(s) upon which storage is provisioned for the data files for the same user-created database.

An instance of a storage tier of type data or type log may be dropped by a user if no databases are currently linked to the storage tier instance. In one embodiment, database system 100 maintains a property associated with each storage tier instance, denoted RefCount, that identifies the number of databases currently linked to the storage tier instance. Thus, a storage tier instance of type data or type log may only be dropped when the RefCount associated with the instance is equal to zero.

A system-provided default instance is provided for each of these storage tier types. The system-provided default instance for type data is named StData and the system-provided default instance for type log is named StLog. Database system 100 initially sets the is_default value for these default instances to true. When a new instance of either of these types is chosen as the default, database system 100 marks the value of is_default as false on the previous default instance automatically. Thus there can be one and only one default instance of each storage tier type in database system 100 at any time.

4. Creation, Alteration and Dropping of Storage Tier Instances

The manner in which a storage tier instance may be created, altered or dropped will now be described. These functions may be performed by any user of database system 100, although it is anticipated that such functions will typically be performed by a database administrator (DBA), storage administrator, or other authorized person or persons responsible for administration of database system 100.

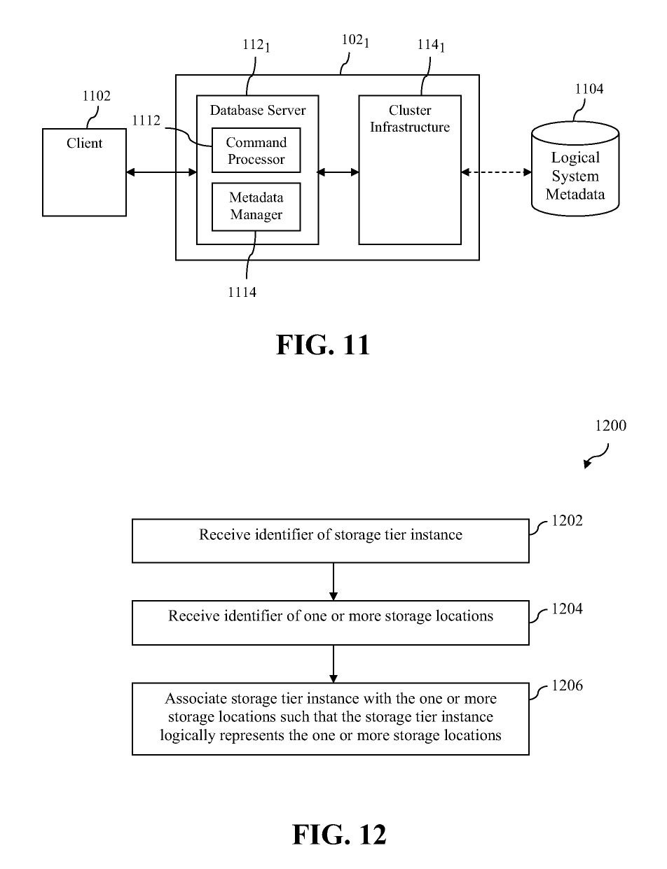

FIG. 11 is a block diagram that depicts entities that may be involved in performing functions relating to the creation, altering or dropping of a storage tier instance. As shown in FIG. 11, these entities include brick 102₁, which includes database server instance 112₁ and cluster infrastructure logic instance 114₁ as discussed above in reference to FIG. 1, although any other brick in database system 100 may be used. A client 1102 is communicatively connected to database server instance 112₁. Such connection may be established over communication infrastructure 104 or via some other communication infrastructure. Cluster infrastructure logic instance 114₁ provides access to logical system metadata 1104, which as discussed above is replicated, or physically persisted, to data storage devices associated with every brick in database system 100.

As further shown in FIG. 11, database server instance 112₁ includes a command processor 1112 and a metadata manager 1114. Command processor 1112 is software logic that is configured to receive and process commands submitted by a user of client 1102, wherein such commands may include commands for creating, altering or dropping a storage tier. Client 1102 provides a user interface by which a user can submit such commands. In one embodiment, the commands comprise Transact-SQL (T-SQL) commands, although the invention is not so limited.

Metadata manager 1114 comprises software logic that is configured, in part, to create, modify or delete metadata associated with storage tiers responsive to the processing of certain commands by command processor 1112. The metadata associated with storage tiers is stored as part of logical system metadata 1104. Since logical system metadata 1104 is physically persisted to data storage devices associated with every brick in database system 100, the creation, modification or deletion of such metadata by metadata manager 1114 is carried out with the assistance of cluster infrastructure logic instance 114₁.

A flowchart 1200 of an example method by which a storage tier may be created is depicted in FIG. 12. The steps of flowchart 1200 are described herein by way of example only and are not intended to limit the present invention. Furthermore, although the steps of flowchart 1200 may be described with reference to various logical and/or physical entities and systems that have been described elsewhere herein, persons skilled in the relevant art(s) will readily appreciate that the method need not be implemented using such entities and systems.

As shown in FIG. 12, the method of flowchart 1200 begins at step 1202 in which command processor 1112 receives an identifier of a storage tier instance. The identifier of the storage tier instance may comprise for example a name to be assigned to the storage tier instance. The identifier of the storage tier instance may be received as part of a command, such as a T-SQL command, submitted to database server instance 112₁ by a user of client 1102.

At step 1204, command processor 1112 receives an identifier of one or more storage locations. The storage location(s) may comprise, for example, one or more storage locations within each of a plurality of data storage devices, wherein each of the plurality of data storage devices is respectively accessible by a different brick within database system 100. As noted elsewhere herein, in certain embodiments, a storage location may comprise a volume or a LUN that identifies one or more volumes. The identifier of a storage location may comprise, for example, a path to a directory. The identifier of the one or more storage locations may be provided as part of a command, such as a T-SQL command, submitted to database server instance 112₁ by a user of client 1102. The command may be the same command used to provide the identifier of the storage tier instance in step 1202.

At step 1206, responsive to receiving the identifier of the storage tier instance in step 1202 and the identifier of the one or more storage locations in step 1204, command processor 1112 associates the storage tier instance identified in step 1202 with the storage location(s) identified in step 1204 such that the storage tier instance logically represents the storage location(s). Command processor 1112 may perform this step, for example, responsive to receiving a command, such as a T-SQL command, that includes the identifier of the storage tier instance and the identifier of the storage location(s). Once the foregoing association has been made, metadata descriptive of the association is stored by metadata manager 1114 as part of logical system metadata 1104 using cluster infrastructure logic instance 114₁.

Once a storage tier instance has been created in accordance with the foregoing method, it can be used by data virtualization manager 604 to automatically store data from system or user-created databases associated with the instance to the storage location(s) identified by the instance. In an embodiment, the relationship between system database files and a storage tier instance is established by database system 100 while the relationship between user-created database files and a storage tier instance may either be established by database system 100 or by a user as part of a database creation process.

The following provides example command syntax for creating a storage tier instance:

CREATE STORAGE TIER storage_tier_name OF TYPE type_name
[ ADD <storage_spec> [, ...]
[;]
<storage_spec>:= (name = storage_spec_name, brick_id = value,
path = path_to_directory)

In the foregoing command, storage tier_name is a name that identifies the storage tier instance to be created, type_name identifies the type of storage tier instance to be created, and <storage_spec> identifies the storage locations to be logically represented by the storage tier instance. In one embodiment, type_name can be one of data or log, wherein such types correspond to the data and log types described above in reference to Table 3. In a further embodiment, <storage_spec> corresponds to a storage specification as described above in reference to Table 2.

The following is an example of the use of the foregoing command syntax to create a new user-defined storage tier instance of the type log:

CREATE STORAGE TIER StLog2 of TYPE LOG
ADD (NAME = WDRIVE, BRICK_ID = 100, PATH = ‘s:\’,
go

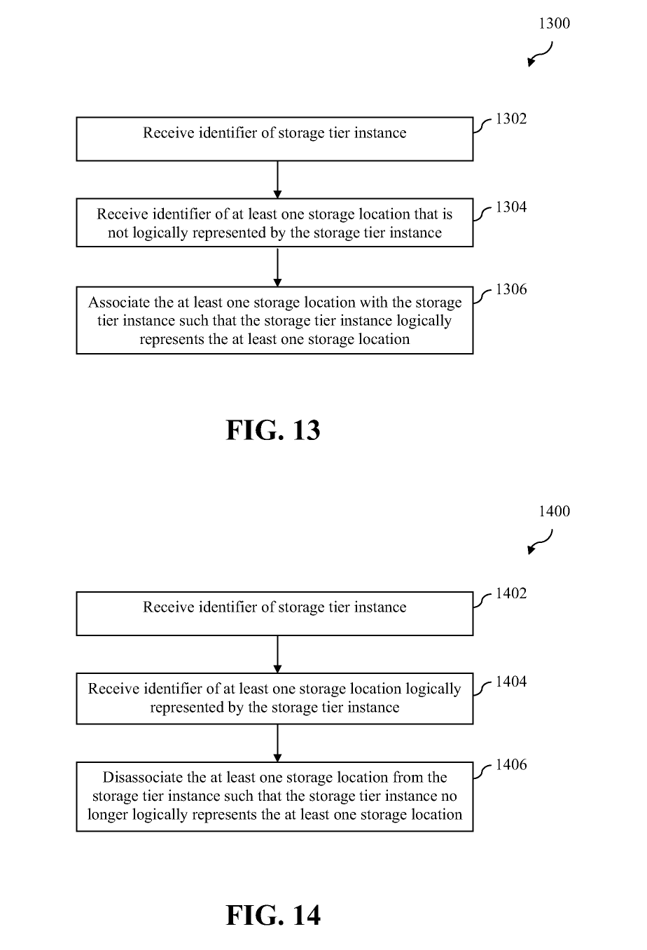

A flowchart 1300 of an example method by which an existing storage tier instance may be altered to associate one or more new storage locations with the storage tier instance is depicted in FIG. 13. The steps of flowchart 1300 are described herein by way of example only and are not intended to limit the present invention. Furthermore, although the steps of flowchart 1300 may be described with reference to various logical and/or physical entities and systems that have been described elsewhere herein, persons skilled in the relevant art(s) will readily appreciate that the method need not be implemented using such entities and systems.

As shown in FIG. 13, the method of flowchart 1300 begins at step 1302 in which command processor 1112 receives an identifier of a storage tier instance. The identifier of the storage tier instance may comprise for example a name that has been assigned to the storage tier instance. The identifier of the storage tier instance may be received as part of a command, such as a T-SQL command, submitted to database server instance 112₁ by a user of client 1102.

At step 1304, command processor 1112 receives an identifier of at least one storage location that is not logically represented by the storage tier instance. The at least one storage location may comprise, for example, a storage location within a data storage device accessible by a particular brick within database system 100. The identifier of the at least one storage location may comprise, for example, a path to a directory. The identifier of the at least one storage location may be provided as part of a command, such as a T-SQL command, submitted to database server instance 112₁ by a user of client 1102. The command may be the same command used to provide the identifier of the storage tier instance in step 1302.

At step 1306, responsive to receiving the identifier of the storage tier instance in step 1302 and the identifier of the at least one storage location in step 1304, command processor 1112 associates the at least one storage location identified in step 1304 with the storage tier instance identified in step 1302 such that the storage tier instance logically represents the at least one storage location. Command processor 1112 may perform this step, for example, responsive to receiving a command, such as a T-SQL command, that includes the identifier of the storage tier instance and the identifier of the at least one storage location. Once the foregoing association has occurred, metadata manager 1114 makes a corresponding modification to metadata associated with the storage tier instance and stored in logical system metadata 1104, wherein such modification is made using cluster infrastructure logic instance 114₁.

Once a storage tier instance has been altered in accordance with the foregoing method, data virtualization manager 604 may automatically store data from database files that have been assigned to the storage tier instance in the associated storage location(s).

A flowchart 1400 of an example method by which an existing storage tier instance may be altered to disassociate one or more storage locations from the storage tier instance is depicted in FIG. 14. The steps of flowchart 1400 are described herein by way of example only and are not intended to limit the present invention. Furthermore, although the steps of flowchart 1400 may be described with reference to various logical and/or physical entities and systems that have been described elsewhere herein, persons skilled in the relevant art(s) will readily appreciate that the method need not be implemented using such entities and systems.

As shown in FIG. 14, the method of flowchart 1400 begins at step 1402 in which command processor 1112 receives an identifier of a storage tier instance. The identifier of the storage tier instance may comprise for example a name that has been assigned to the storage tier instance. The identifier of the storage tier instance may be received as part of a command, such as a T-SQL command, submitted to database server instance 112₁ by a user of client 1102.

At step 1404, command processor 1112 receives an identifier of at least one storage location logically represented by the storage tier instance. The at least one storage location may comprise, for example, a storage location within a data storage device accessible by a particular brick within database system 100. The identifier of the at least one storage location may comprise for example a path to a directory. The identifier of the at least one storage location may be provided as part of a command, such as a T-SQL command, submitted to database server instance 112₁ by a user of client 1102. The command may be the same command used to provide the identifier of the storage tier instance in step 1402.

At step 1406, responsive to receiving the identifier of the storage tier instance in step 1402 and the identifier of the at least one storage location in step 1404, command processor 1112 disassociates the at least one storage location identified in step 1404 from the storage tier instance identified in step 1402 such that the storage tier instance no longer logically represents the at least one storage location. Command processor 1112 may perform this step, for example, responsive to receiving a command, such as a T-SQL command, that includes the identifier of the storage tier instance and the identifier of the at least one storage location. Once the foregoing disassociation has occurred, metadata manager 1114 makes a corresponding modification to metadata associated with the storage tier instance and stored in logical system metadata 1104, wherein such modification is made using cluster infrastructure logic instance 114₁.

Once a storage tier instance has been altered in accordance with the foregoing method, data virtualization manager 604 may automatically remove data from database files that have been assigned to the storage tier instance from the disassociated storage location(s).

The following provides example command syntax for altering a storage tier instance:

```
ALTER STORAGE TIER storage_tier_name
    [ ADD <storage_spec> [, ...n] ]
    [ REMOVE STORAGE_SPEC = storage_spec_name [, ...n] ]
    [ MODIFY Name = new_storage_tier_name]
[;]
```

In the foregoing command, storage_tier_name is a name that identifies the storage tier instance to be altered. The ADD, REMOVE STORAGE_SPEC, and MODIFY sub-commands can each be included within an ALTER STORAGE TIER command to add storage locations to a storage tier, remove storage locations from a storage tier, or modify a storage tier name, respectively.

The following is an example of the use of the foregoing command syntax to provision some storage to the default storage tier instance of type data:

```
ALTER STORAGE TIER StData
    ADD (NAME = CDRIVE, BRICK_ID = 100, PATH = ‘c:\’,
    ADD (NAME = XDRIVE, BRICK_ID = 100, PATH = ‘x:\’)
go
```

The following is another example of the use of the foregoing command syntax to provision some storage to the default storage tier instance of type log:

```
ALTER STORAGE TIER StLog
    ADD (NAME = SDRIVE, BRICK_ID = 100, PATH = ‘s:\’,
    ADD (NAME = TDRIVE, BRICK_ID = 100, PATH = ‘t:\’)
go
```

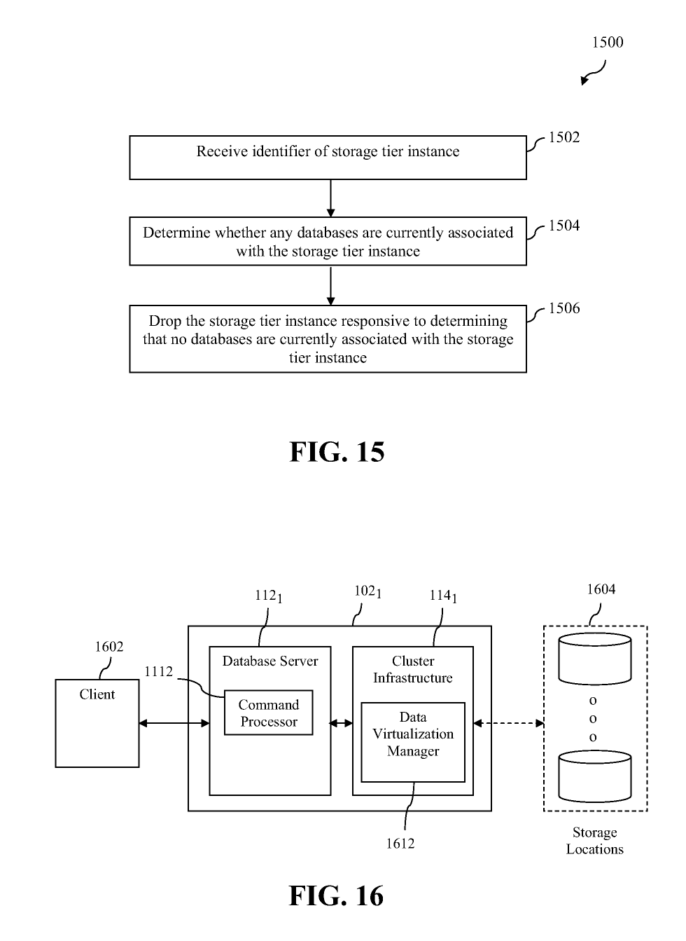

FIG. 15 depicts a flowchart of an example method by which an existing storage tier instance may be dropped. The steps of flowchart 1500 are described herein by way of example only and are not intended to limit the present invention. Furthermore, although the steps of flowchart 1500 may be described with reference to various logical and/or physical entities and systems that have been described elsewhere herein, persons skilled in the relevant art(s) will readily appreciate that the method need not be implemented using such entities and systems.

As shown in FIG. 15, the method of flowchart 1500 begins at step 1502 in which command processor 1112 receives an identifier of a storage tier instance. The identifier of the storage tier instance may comprise for example a name that has been assigned to the storage tier instance. The identifier of the storage tier instance may be received as part of a command, such as a T-SQL command, submitted to database server instance 112₁ by a user of client 1102.

At step 1504, command processor 1112 determines whether there are any databases currently associated with the storage tier instance identified in step 1502. In one embodiment, database system 100 maintains a property associated with each storage tier instance, denoted RefCount, that identifies the number of databases currently linked to the storage tier instance. Thus, command processor 1112 may determine whether there are any databases currently associated with the storage tier instance identified in step 1502 by analyzing the value of RefCount. If RefCount is greater than 0, then one or more databases are currently associated with the storage tier instance. If RefCount is equal to 0, then there are no databases currently associated with the storage tier instance.

At step 1506, responsive to receiving the identifier of the storage tier instance in step 1502 and determining that no databases are currently associated with the identified storage tier instance, command processor 1112 drops the identified storage tier instance. Command processor 1112 may perform this step, for example, responsive to receiving a command, such as a T-SQL command, that includes the identifier of the storage tier instance. Once the storage tier instance has been dropped, metadata manager 1114 deletes metadata associated with the storage tier instance from logical system metadata 1104, wherein such deletion is performed using cluster infrastructure logic instance 114₁.

The following provides example command syntax for dropping a storage tier instance:

DROP STORAGE TIER storage_tier_name
[;]

In the foregoing command, storage_tier_name is a name that identifies the storage tier instance to be dropped.

5. Assignment of Database to Storage Tier Instances and Storage in Accordance Therewith

The manner in which a database may be assigned to a storage tier instance and stored in accordance therewith will now be described. An association between a particular database and a particular storage tier instance may be automatically provisioned by database system 100 or may be created by a user as part of a database creation process. The storage of data from a database across one or more storage locations logically represented by the storage tier instance is a process handled automatically by a data virtualization manager, such as data virtualization manager 604 as described above in reference to FIG. 6.

FIG. 16 is a block diagram that depicts entities that may be involved in performing functions relating to the assignment of a database to a storage tier instance and the storage of data from the database in accordance therewith. As shown in FIG. 16, these entities include brick 102₁, which includes database server instance 112₁ and cluster infrastructure logic instance 114₁ as discussed above in reference to FIG. 1, although any other brick in database system 100 may be used. A client 1602 is communicatively connected to database server instance 112₁. Such connection may be established over communication infrastructure 104 or via some other communication infrastructure.

As further shown in FIG. 11, database server instance 112₁ includes a command processor 1112. Command processor 1112 is software logic that is configured to receive and process commands submitted by a user of client 1602, wherein such commands may include commands relating to the creation of a database. Client 1602 provides a user interface by which a user can submit such commands. In one embodiment, the commands comprise T-SQL commands, although the invention is not so limited.

Cluster infrastructure logic instance 114₁ includes a data virtualization manager 1612 that is configured to store data from the created database to any of a plurality of storage locations 1604 logically represented by a storage tier instance associated with the database. Each of the storage locations may be located within a different data storage device accessible to a different computer system within database system 100.

In an alternate embodiment, data virtualization manager 1612 is included within an instance of cluster infrastructure logic in database system 100 other than cluster infrastructure logic instance 114₁ and cluster infrastructure logic instance 114₁ includes a data virtualization manager agent that is configured to communicate therewith to cause data virtualization manager 1612 to perform the aforementioned functions.

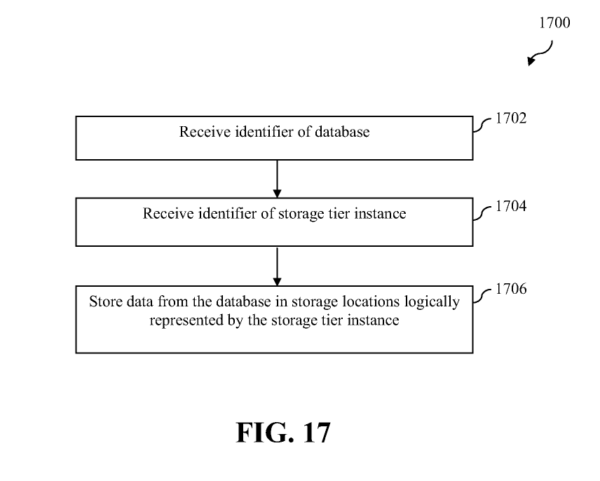

A flowchart 1700 of an example method by which a database may be associated with a storage tier instance and by which data from the database may be stored in accordance therewith is depicted in FIG. 17. The steps of flowchart 1700 are described herein by way of example only and are not intended to limit the present invention. Furthermore, although the steps of flowchart 1700 may be described with reference to various logical and/or physical entities and systems that have been described elsewhere herein, persons skilled in the relevant art(s) will readily appreciate that the method need not be implemented using such entities and systems.

As shown in FIG. 17, the method of flowchart 1700 begins at step 1702 in which command processor 1112 receives an identifier of a database. In one embodiment, the identifier of the database comprises an identifier of a file group. The identifier of the file group may be received as part of a command, such as a T-SQL command, submitted to database server instance 112₁ by a user of client 1602.

At step 1704, command processor 1112 receives an identifier of a storage tier instance. The identifier of the storage tier instance may comprise for example a name that has been assigned to the storage tier instance. The identifier of the storage tier instance may be received as part of a command, such as a T-SQL command, submitted to database server instance 112₁ by a user of client 1102. The command may be the same command used to provide the identifier of the database in step 1702.

At step 1706, data virtualization manager 1612 stores data from the database identified in step 1702 in storage locations 1604 logically represented by the storage tier instance identified in step 1704. Depending upon the implementation, this may involve storing data in a file format or a raw storage format. This may also involve storing data from the database in storage locations that are located within different data storage devices associated with different computer systems within system 100. Data virtualization manager 1612 may perform this function by sending commands to data virtualization manager agents executing on such different computer systems. Depending upon different factors, this step may include storing a clone of different fragments of data from the database in each of the different storage locations, storing a clone of the same fragment of data from the database in each of the storage locations, or both. In an embodiment, this step may also involve storing data from the database in storage locations that are located within the same data storage device.

The following provides example command syntax for creating a database and associating storage tiers with file groups/log group of the database:

```
CREATE DATABASE database_name
    [ ON
        [ PRIMARY ] [ <filegroup_spec>
        [ , <filegroup> [ , ...n] ]
    [ LOG ON { <filegroup_spec> } ]
    ]
    [ COLLATE collation_name ]
    [ WITH <external_access_option> ]
]
[;]
<filegroup_spec> ::=
{
(
    STORAGETIER = ‘storage_tier_name’
        [ , REDUNDANCY_FACTOR = redundancy_factor ]
        [ , INITIALSIZE = size [ KB | MB | GB | TB ] ]
        [ , MAXSIZE = { max_size [ KB | MB | GB | TB ] |
                    UNLIMITED } ]
        [ , FILEGROWTH = growth_increment [ KB | MB | GB | TB
                    | % ] ]
)
}
```

In the foregoing command, database_name is a name that identifies the database being created. A file group specification, denoted <filegroup_spec>, that follows the command term PRIMARY includes the name of a storage tier instance that will be assigned to the primary file group of the database. Another file group specification that follows the command term LOG ON includes the name of a storage tier instance that will be assigned to the log files of the database. Other user-created file groups, represented by “<filegroup>[, . . . n]”, can also be assigned to storage tiers using a file group specification.

As also shown by the example command syntax, a file group specification includes various properties that may be set on a file or log group. These include REDUNDANCY_FACTOR, INITIALSIZE, MAXSIZE and FILEGROWTH. The property REDUNDANCY_FACTOR specifies the number of clones to be created for each fragment of the objects contained in the file group. The property INITIALSIZE represents the initial size of any file created in that file group by the system for persisting/storing information. The property MAXSIZE specifies the maximum amount of space occupied by the file group, including the space occupied by clones. The property FILEGROWTH specifies the increment by which every file in the file group is grown.

The following is an example of the use of the foregoing command syntax to create a database named MyDB:

```
CREATE DATABASE MyDB
ON PRIMARY
    ( STORAGETIER = ‘StData’,
      INITIALSIZE = 4 MB,
      MAXSIZE = 10 MB,
      FILEGROWTH = 1 MB),
FILEGROUP MyDB_FG1
    ( STORAGETIER = ‘StTier1’,
      INITIALSIZE = 1 MB,
      MAXSIZE = 20 MB,
FILEGROWTH = 1 MB),
LOG ON
    ( STORAGETIER = ‘StLog’,
      INITIALSIZE = 1 MB,
      MAXSIZE = 10 MB,
      FILEGROWTH = 1 MB) ;
```

Here the primary file group of database MyDB is assigned to the system-provided instance of the storage tier type data, which is named StData, the log files of database MyDB are assigned to the system-provided instance of the storage tier type log, which is named StLog, and the user-created file group MyDB_FG1 is assigned to the user-created storage tier instance of type data named StTier1.
The following is another example of the use of the foregoing command syntax to create a database named testdb1:

```
CREATE DATABASE testdb1
ON PRIMARY (
    STORAGETIER = StData1,
    REDUNDANCY_FACTOR = 3)
LOG ON (
    STORAGETIER = StLog1)
go
```

Here the primary file group of database testdb1 will be assigned to the user-created storage tier instance named StData1 and the log files of database testdb1 will be assigned to the user-created storage tier instance named StLog1.

The following is yet another example of the use of the foregoing command syntax to create a database named testdb2:

CREATE DATABASE testdb2
go

Here, since no storage tiers are explicitly specified, command processor 1112 will assign the primary file group of database testdb2 to the default instance of the storage tier type data and will assign the log files of database testdb2 to the default instance of the storage tier type log. In this example, the identifier of the database file received in step 1702 of flowchart 1700 and the identifier of the storage tier instance received in step 1704 are not provided via a user command but instead are provided by database system 100 itself.

The process of flowchart 1700 may also be performed to store system database files in accordance with an associated storage tier. In this case, database system 100 provides the identifier of both the system database file and the associated storage tier instance and a data virtualization manager, such as data virtualization manager 604 of FIG. 6 stores the database file in one or more storage locations logically represented by the storage tier. For example, database system 100 specifies that the log files for system database tempdb are associated with the system-provided storage tier instance StTempLog and data virtualization manager 604 stores the log files for system database tempdb across the storage locations logically represented by storage tier StTempLog.

6. Assignment of Policies to Storage Tiers

In accordance with a further embodiment of the invention, policies can be introduced in association with storage tiers in order to provide a user with the ability to control the storage or placement of diverse sets of objects within a database. In accordance with such an embodiment, security schemes may be implemented, for example, that control who can create, alter or drop a storage tier, or who can store files associated with a created database on a particular storage tier. Other policies may be specified as well.

### C. Example Computer System Implementation

FIG. 18 depicts an exemplary implementation of a computer system 1800 upon which various aspects of the present invention may be executed. Computer system 1800 is intended to represent a general-purpose computing system in the form of a conventional personal computer.

As shown in FIG. 15, computer system 1800 includes a processing unit 1802, a system memory 1804, and a bus 1806 that couples various system components including system memory 1804 to processing unit 1802. Bus 1806 represents one or more of any of several types of bus structures, including a memory bus or memory controller, a peripheral bus, an accelerated graphics port, and a processor or local bus using any of a variety of bus architectures. System memory 1804 includes read only memory (ROM) 1808 and random access memory (RAM) 1810. A basic input/output system 1812 (BIOS) is stored in ROM 1808.

Computer system 1800 also has one or more of the following drives: a hard disk drive 1814 for reading from and writing to a hard disk, a magnetic disk drive 1816 for reading from or writing to a removable magnetic disk 1818, and an optical disk drive 1820 for reading from or writing to a removable optical disk 1822 such as a CD ROM, DVD ROM, or other optical media. Hard disk drive 1814, magnetic disk drive 1816, and optical disk drive 1820 are connected to bus 1806 by a hard disk drive interface 1824, a magnetic disk drive interface 1826, and an optical drive interface 1828, respectively. The drives and their associated computer-readable media provide nonvolatile storage of computer-readable instructions, data structures, program modules and other data for the server computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1830, one or more application programs 1832, other program modules 1834, and program data 1836. Application programs 1832 or program modules 1834 may include, for example, logic for implementing a database server instance and a cluster infrastructure logic instance as described herein. Application programs 1832 or program modules 1834 may also include, for example, logic for implementing one or more of the steps of the flowcharts depicted in FIGS. 12-15 and 17. Thus each step illustrated in those figures may also be thought of as program logic configured to perform the function described by that step.

A user may enter commands and information into computer 1800 through input devices such as keyboard 1838 and pointing device 1840. Other input devices (not shown) may include a microphone, joystick, game pad, satellite dish, scanner, or the like. These and other input devices are often connected to the processing unit 1802 through a serial port interface 1842 that is coupled to bus 1806, but may be connected by other interfaces, such as a parallel port, game port, or a universal serial bus (USB).

A monitor 1844 or other type of display device is also connected to bus 1806 via an interface, such as a video adapter 1846. Monitor 1844 is used to present a GUI that assists a user/operator in configuring and controlling computer 1800. In addition to the monitor, computer 1800 may include other peripheral output devices (not shown) such as speakers and printers.

Computer 1800 is connected to a network 1848 (e.g., a WAN such as the Internet or a LAN) through a network interface 1850, a modem 1852, or other means for establishing communications over the network. Modem 1852, which may be internal or external, is connected to bus 1806 via serial port interface 1842.

As used herein, the terms “computer program medium” and “computer-readable medium” are used to generally refer to media such as the hard disk associated with hard disk drive 1814, removable magnetic disk 1818, removable optical disk 1822, as well as other media such as flash memory cards, digital video disks, random access memories (RAMs), read only memories (ROM), and the like.

As noted above, computer programs (including application programs 1832 and other program modules 1834) may be stored on the hard disk, magnetic disk, optical disk, ROM, or RAM. Such computer programs may also be received via network interface 1850 or serial port interface 1842. Such computer programs, when executed, enable computer 1800 to implement features of the present invention discussed herein. Accordingly, such computer programs represent controllers of computer 1800.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### D. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for storing data from a database across a plurality of data storage devices, wherein each data storage device is capable of being accessed only by a corresponding computer system in a group of interconnected computer systems, the method comprising:
receiving an identifier of the database;
receiving an identifier of a storage tier instance, wherein the storage tier instance comprises a logical representation of one or more storage locations within each of the data storage devices; and
responsive to receiving the identifier of the database and the identifier of the storage tier instance, storing data from the database in two or more of the storage locations logically represented by the storage tier instance, wherein each of the two or more storage locations in which data is stored is within a corresponding one of the data storage devices.

2. The method of claim 1, wherein receiving an identifier of the database comprises:
receiving an identifier of a file group that is included in the database.

3. The method of claim 1, wherein storing data from the database in two or more of the storage locations logically represented by the storage tier instance comprises:
storing fragments of data from the database in each of the two or more storage locations.

4. The method of claim 1, wherein storing data from the database in two or more of the storage locations logically represented by the storage tier instance comprises:
storing copies of the same fragment of data from the database in each of the two or more storage locations.

5. The method of claim 1, further comprising creating the storage tier instance, wherein creating the storage tier instance comprises:
receiving the identifier of the storage tier instance;
receiving an identifier of each of the one or more storage locations within each of the data storage devices; and
responsive to receiving the identifier of the storage tier instance and the identifier of each of the one or more storage locations within each of the data storage devices, associating the storage tier instance with the one or more storage locations within each of the data storage devices.

6. The method of claim 1, further comprising altering the storage tier instance, wherein altering the storage tier instance comprises:
receiving the identifier of the storage tier instance;
receiving an identifier of at least one storage location within at least one of the data storage devices that is not logically represented by the storage tier instance; and
responsive to receiving the identifier of the storage tier instance and the identifier of the at least one storage location that is not logically represented by the storage tier instance, associating the at least one storage area with the storage tier instance such that the storage tier instance logically represents the at least one storage area.

7. The method of claim 6, further comprising:
responsive to the altering of the storage tier instance, storing data from the database in the at least one storage location.

8. The method of claim 1, further comprising altering the storage tier instance, wherein altering the storage tier instance comprises:
receiving the identifier of the storage tier instance;
receiving an identifier of at least one storage location logically represented by the storage tier instance;
responsive to receiving the identifier of the storage tier instance and the identifier of the at least one storage location logically represented by the storage tier instance, disassociating the at least one storage location from the storage tier instance such that the storage tier instance no longer logically represents the at least one storage location.

9. The method of claim 8, further comprising:
responsive to the altering of the storage tier instance, removing data from the database from the at least one storage location.

10. A system, comprising:
a plurality of interconnected computer systems;
a plurality of data storage devices, each of the data storage devices being connected to a corresponding one of the interconnected computer systems and solely accessible thereto; and
computer program logic executing on at least one of the interconnected computer systems, the computer program logic comprising:
a command processor that is configured to receive an identifier of a database and to receive an identifier of a storage tier instance, wherein the storage tier instance comprises a logical representation of one or more storage locations within each of the data storage devices; and
a data virtualization manager that is configured to store data from the database in two or more of the storage locations logically represented by the storage tier instance responsive to receipt of the identifier of the database and the identifier of the storage tier instance by the command processor, wherein each of the two or more storage locations in which data is stored is within a corresponding one of the data storage devices.

11. The system of clam 10, wherein the command processor is configured to receive an identifier of the database by receiving an identifier of a file group that is included in the database.

12. The system of claim 10, wherein the data virtualization manager is configured to store fragments of data from the database in each of the two or more storage locations.

13. The system of claim 10, wherein the data virtualization manager is configured to store copies of the same fragment of data from the database in each of the two or more storage locations.

14. The system of claim 10, wherein the command processor is further configured to receive the identifier of the storage tier instance, to receive an identifier of each of the one or more storage locations within each of the data storage devices, and to associate the storage tier instance with the one or more storage locations within each of the data storage devices responsive to receiving the identifier of the storage tier instance and the identifier of each of the one or more storage locations within each of the data storage devices.

15. The system of claim 10, wherein the command processor is further configured to receive the identifier of the storage tier instance, to receive an identifier of at least one storage location within at least one of the data storage devices that is not logically represented by the storage tier instance, and to associate the at least one storage location with the storage tier instance such that the storage tier instance logically represents the at least one storage location responsive to receiving the identifier of the storage tier instance and the identifier of the at least one storage location that is not logically represented by the storage tier instance.

16. The system of claim 15, wherein the data virtualization manager is further configured to store data from the database in the at least one storage location responsive to the association of the at least one storage location with the storage tier instance.

17. The system of claim 10, wherein the command processor is further configured to receive the identifier of the storage tier instance, to receive an identifier of at least one storage location logically represented by the storage tier instance, and to disassociate the at least one storage location from the storage tier instance such that the storage tier instance no longer logically represents the at least one storage location responsive to receiving the identifier of the storage tier instance and the identifier of the at least one storage area logically represented by the storage tier instance.

18. The system of claim 17, wherein the data virtualization manager is further configured to remove data from the database from the at least one storage location responsive to the disassociation of the at least one storage location from the storage tier instance.

19. The system of claim 10, wherein the data virtualization manager is configured to store data from the database in two or more of the storage locations logically represented by the storage tier by sending commands to data virtualization manager agents executing on two or more of the interconnected computer systems.

20. A computer program product comprising a computer-readable medium having computer program logic recorded thereon for enabling a processing unit to store data from a database across a plurality of data storage devices, wherein each data storage device is capable of being accessed only by a corresponding computer system in a group of interconnected computer systems, the computer program logic comprising:
first means for enabling the processing unit to receive an identifier of the database;
second means for enabling the processing unit to receive an identifier of a storage tier instance, wherein the storage tier instance comprises a logical representation of one or more storage locations within each of the data storage devices; and
third means for enabling the processor to store data from the database in two or more of the storage locations logically represented by the storage tier instance responsive to receiving the identifier of the database and the identifier of the storage tier instance, wherein each of the two or more storage locations in which data is stored is within a corresponding one of the data storage devices.
